(19) United States
(12) Patent Application Publication
(10) Pub. No.: US 2017/0227451 A1
(43) Pub. Date: Aug. 10, 2017

(54) SENSOR SYSTEMS, MULTI-BOREHOLE MONITORING SYSTEMS, AND RELATED METHODS

(71) Applicant: Baker Hughes Incorporated, Houston, TX (US)

(72) Inventors: Manuel Peter Hoegerl, Al Khobar (SA); Abdulaziz Abdulrhman AlMathami, Al Dammam (SA); Gaurav Agrawal, Aurora, CO (US)

(21) Appl. No.: 15/040,401

(22) Filed: Feb. 10, 2016

(51) Int. Cl. G01N 17/04; E21B 47/00

(52) U.S. Cl. CPC G01N 17/04; E21B 47/00

(57) ABSTRACT

A sensor system for monitoring downhole corrosion may include a first test sample and a second test sample for measuring corrosion conditions and collecting data related to the corrosion conditions and an electronic circuit. The electronic circuit may include a measuring device for analyzing the first test sample and the second test sample and to obtain corrosion data related to the corrosion conditions and a communication module for transmitting the corrosion data related to the corrosion conditions to a surface above the borehole. A multi-borehole monitoring system may include a plurality of sensor systems disposed in a plurality of boreholes and a monitoring module. The monitoring module may analyze the corrosion data, to manipulate the corrosion data, and to produce a visual representation of the corrosion data. Methods of monitoring corrosion downhole may include receiving the corrosion data at the multi-borehole monitoring system from the plurality of plurality of sensor systems.

### CROSS-REFERENCE TO RELATED APPLICATION

The subject matter of this application is related to the subject matter of U.S. patent application Ser. No. 15/______, (attorney docket number 1684.04-P13139US), “Sample Arrays For Monitoring Corrosion and Related Methods,” filed on even date herewith, the entire disclosure of which is hereby incorporated herein by this reference.

### FIELD

Embodiments of the present disclosure relate generally to sensor systems for monitoring corrosion downhole, such as in downhole environments and in petroleum processing operations. Embodiments of the present disclosure further relate to multi-borehole monitoring systems and methods of monitoring corrosion downhole.

### BACKGROUND

Corrosion may occur during various operations within the oil-and-gas industry, such as in upstream (e.g., exploration and drilling), midstream (e.g., pipelines) or downstream (e.g., refining, distribution, etc.) operations. Corrosion may also occur throughout various chemical processing industries, and is a major source of expense and delay when equipment failures occur. Measurement of corrosion as a function of exposure time is typically difficult because parts may need to be removed from service for evaluation. Furthermore, modeling or simulation of corrosion can be difficult when process conditions are variable.

The oil and gas industry expends sizable sums to design cutting tools, such as downhole drill bits including roller-cone rock bits and fixed-cutter bits. Such drill bits may have relatively long service lives with relatively infrequent failure. In particular, considerable sums are expended to design and manufacture roller-cone rock bits and fixed-cutter bits in a manner that minimizes the probability of catastrophic drill bit failure during drilling operations. The loss of a roller cone or a polycrystalline diamond compact from a bit during drilling operations can impede the drilling operations and, at worst, necessitate rather expensive operations for retrieving the bit or components thereof from the wellbore.

Diagnostic information related to a drill bit and certain components of the drill bit may be linked to the durability, performance, and the potential failure of the drill bit. In addition, characteristic information regarding the rock formation may be used to estimate performance and other characteristics related to drilling operations. Logging while drilling (LWD) and measuring while drilling (MWD) measurements are conventionally obtained from measurements behind (e.g., several feet away from) the drill head.

Drill bits, other drilling tools, as well as logging subs and tools including instruments and other downhole assemblies used for oil and gas exploration and production are often exposed to corrosive conditions, such as high temperatures, high pressures, reactive chemicals, and abrasive materials. Therefore, these bits, subs, tools, and other downhole components corrode and degrade during use. In addition, scale (i.e., debris and materials from the wellbore or from fluids therein) may be deposited on such downhole components used for exploration and production of oil and gas, which may foul the operation of the tools and create flow restrictions. Corrosion may occur throughout a subterranean formation and in processing equipment, and may vary with time and location. Surface monitoring of chemical variables related to corrosion may be of some value, but may not be fully representative of downhole conditions due to changes in temperature and pressure that occur between the formation and the surface.

Corrosion monitoring is also important for surface systems and components, such as pipelines, pumps, turbines, tanks, and any other devices. Corrosion monitoring may be particularly important for systems under pressure, systems in contact with particularly hazardous materials, or systems in close proximity to inhabited areas. Extraction of fluid samples for testing variables related to corrosion may be of some value, but may not be fully representative of process conditions due to changes in temperature and pressure that occur when samples are extracted.

### BRIEF SUMMARY

Some embodiments of the present disclosure include a sensor system for monitoring corrosion. The sensor system may include a sensor array and an electronic circuit operably coupled to the sample array. The sample array may include a substrate, a corrosion proxy coupled to the substrate and comprising a corrodible material, a first test sample coupled to the substrate, the first test sample formulated and configured to measure a first corrosion condition, and a second test sample coupled to the substrate, the second test sample formulated and configured to measure a second corrosion condition. The electronic circuit may include a measuring device coupled to the first test sample and the second test sample and configured to analyze the first test sample and the second test sample and to obtain corrosion data related to the first corrosion condition and the second corrosion condition, a processor electrically and operably coupled to the measuring device and configured to process the corrosion data related to the first corrosion condition and the second corrosion condition, and a communication module having a transmitter and operably coupled to the processor and configured to transmit the corrosion data related to the first corrosion condition and the second corrosion condition to a surface above a borehole.

Some embodiments of the present disclosure include a multi-borehole monitoring system for monitoring downhole corrosion in multiple boreholes. The multi-borehole monitoring system may include a plurality of sensor systems disposed in multiple boreholes within a geographical area and a monitoring module in communication with the plurality of sensor systems. Each sensor system of the plurality of sensor systems may include a first test sample formulated and configured to measure a first corrosion condition of a respective borehole, a second test sample formulated and configured to measure a second corrosion condition of a respective borehole, and an electronic circuit operably coupled to the first test sample and the second test sample. The electronic circuit may include a measuring device configured to analyze the first test sample and the second test sample and to obtain corrosion data related to the first corrosion condition and the second corrosion condition, a processor electrically and operably coupled to the measuring device and configured to receive the corrosion data related to the first corrosion condition and the second corrosion condition from the measuring device, and a communication module operably coupled to the processor and configured to transmit the corrosion data related to the first corrosion condition and the second corrosion condition. The monitoring module may include a receiver for receiving the corrosion data from the communication module of each sensor system of the plurality of sensor systems, a central processing unit operably coupled to the receiver and configured to process the corrosion data received by the receiver, and a memory storage medium operably coupled to the central processing unit, wherein the monitoring module is configured to analyze the corrosion data received by the receiver, to manipulate the corrosion data, and to produce a visual representation of the corrosion data.

Some embodiments of the present disclosure include a method of monitoring downhole conditions. The method may include disposing a sensor system in a borehole formed in a subterranean formation. The sensor system may include a first test sample formulated and configured to measure a first corrosion condition of the borehole, a second test sample formulated and configured to measure a second corrosion condition of the borehole, and an electronic circuit operably coupled to the first test sample and the second test sample. The electronic circuit may include a measuring device configured to analyze the first test sample and the second test sample and to obtain corrosion data related to the first corrosion condition and the second corrosion condition, a processor electrically and operably coupled to the measuring device and configured to receive the corrosion data related to the first corrosion condition and the second corrosion condition from the measuring device, and a communication module having a transmitter operably coupled to the processor and configured to transmit the corrosion data related to the first corrosion condition and the second corrosion condition. The method may also include causing the measuring device to analyze the first test sample and the second test sample and to obtain the corrosion data related to the first corrosion condition and the second corrosion condition, and causing the communication module to transmit the corrosion data related to the first corrosion condition and the second corrosion condition to a receiver of a multi-borehole monitoring system located at a ground surface of the subterranean formation

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified schematic view illustrating a sample array for monitoring corrosion;

FIG. 2 is a simplified schematic side view of a test sample;

FIG. 3 is a simplified schematic diagram illustrating a cross-section of a subterranean formation, and shows how the sample array shown in FIG. 1 may be used to monitor properties associated with corrosion;

FIG. 4 is a simplified schematic block diagram of a sensor sample array shown in FIG. 1;

FIG. 5 is a simplified schematic view of a sensor system for monitoring corrosion according to an embodiment of the present disclosure;

FIG. 6 is a simplified schematic view of a measuring device of a sensor system according to an embodiment of the present disclosure;

FIG. 7 is a simplified schematic view of another measuring device of a sensor system according to an embodiment of the present disclosure;

FIG. 8 is a simplified schematic view of a multi-borehole monitoring system for monitoring corrosion according to an embodiment of the present disclosure;

FIG. 9 is a simplified schematic view of a monitoring module according to an embodiment of the present disclosure of FIG. 8; and

FIG. 10 is an example visual representation of a subsurface map that may be produced by the multi-borehole monitoring system of FIG. 8.

### DETAILED DESCRIPTION

The illustrations presented herein are not meant to be actual views of any particular material, apparatus, system, or method, but are merely idealized representations employed to describe certain embodiments. For clarity in description, various features and elements common among the embodiments may be referenced with the same or similar reference numerals.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, any relational term, such as “first,” “second,” “over,” “top,” “bottom,” “underlying,” etc., is used for clarity and convenience in understanding the disclosure and accompanying drawings and does not connote or depend on any specific preference, orientation, or order, except where the context clearly indicates otherwise.

As used herein, the term “corrosion” means physical and/or chemical degradation.

As used herein, the term “corrodible” in reference to a material means susceptible to corrosion in an environment in which the material is to be placed.

As used herein, the term “particle” means and includes any coherent volume of solid matter. As used herein, the term “nanoparticle” means and includes any particle having an average particle diameter of about 100 nm or less.

As used herein, the term “nano-structured material” means and includes any solid material having a largest dimension of about 100 nm or less. Nano-structured materials include needles, brushes, pins, cubes, etc.

As used herein, the term “test sample” means and includes an active or passive body formulated and/or configured to respond to a change in conditions. Test samples include electronic devices, such as thermocouples, transducers, pH meters, etc., as well as reactive materials, substrates having reactive layers thereon, or any other body capable of reacting to conditions.

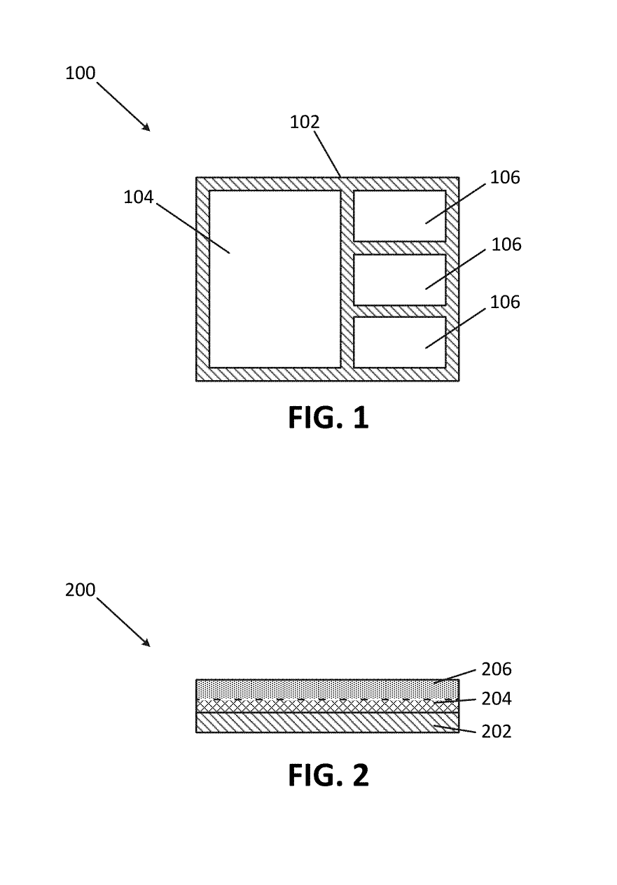

FIG. 1 is a simplified schematic view illustrating a sample array 100 for monitoring downhole corrosion. The sample array 100 may include a substrate 102 to which a corrosion proxy 104 and test samples 106 may be coupled. Though shown as having three test samples 106, the sample array 100 may include any number of test samples 106, such as one, two, four, five, etc.

The substrate 102 may be any structure configured to provide physical support for the corrosion proxy 104 and the test samples 106. In some embodiments, the substrate 102 may include a silicon or silicon dioxide wafer. The substrate 102 may be formulated to be inert when exposed to the conditions expected to be encountered by the sample array 100, such that the substrate 102 may retain its physical characteristics while the sample array 100 is in use. The substrate 102 may include one or more layers of material.

The corrosion proxy 104 may be any material formulated and configured to corrode in response to a corrosive environment. The corrosion proxy 104 may include one or more metal plates mounted in an insulating material (which may be referred to in the art as a “coupon”), and may have a generally planar surface configured to be exposed to drilling fluid. The use of corrodible coupons to estimate corrosion is described in U.S. Pat. No. 4,603,113, “Corrosion Testing,” issued Jul. 29, 1986, the entire disclosure of which is hereby incorporated by this reference. The corrosion proxy 104 may be selected to include a material selected to have a similar composition to materials commonly used in forming or servicing wellbores, such as carbon steel, zinc oxide, stainless steel, a nickel alloy, a braze material, a hardfacing material, solder, etc. The corrosion proxy 104 may be a sacrificial material, and may be a corrodible material configured to be at least partially consumed during a test.

In some embodiments, the corrosion proxy 104 may include a nano-structured material. For example, the corrosion proxy 104 may include a nano-structured material (e.g., a layer of nanoparticles) bonded to a substrate. The nano-structured material may include a material used in tools and components thereof used in wellbores, such as carbon steel, zinc oxide, stainless steel, a nickel alloy, a braze material, a hardfacing material, solder, etc. Nano-structured materials may experience corrosion at higher rates than flat plates, due to the increased surface area per volume. Thus, if the corrosion proxy 104 includes a nano-structured material, it may exhibit a physical or chemical change in response to a relatively less corrosive environment or over relatively shorter sampling times than conventional coupons. Such a corrosion proxy 104 may be able to provide statistically meaningful results after a few hours or days in a corrosive environment, instead of weeks or months that may be required for conventional coupons. A corrosion proxy 104 that includes a nano-structured material may be capable of producing data with a higher signal-to-noise ratio than conventional coupons.

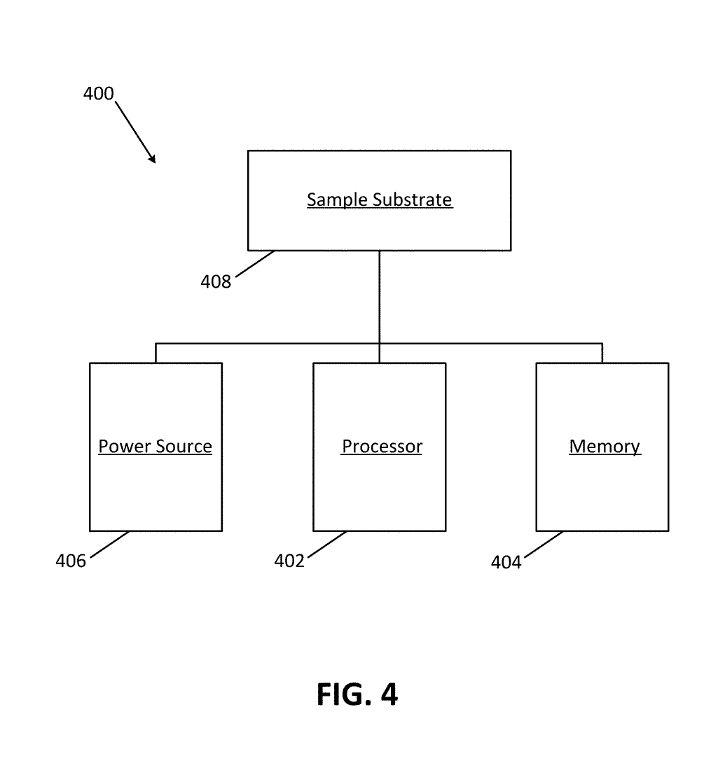

In some embodiments, the test samples 106 may include various physical or chemical detectors or sensors. For example, test samples 106 configured for detecting physical properties may include pressure sensors, temperature sensors, fluid flow sensors, vibration detectors, accelerometers, and electromagnetic field sensors. Such a test sample 106 may include an electronic device, such as a thermocouple or piezoelectric transducer, which may be configured to transmit a signal to an electronic circuit. The electronic circuit may be included within the test sample 106, or may be external. FIG. 4 illustrates a simplified schematic block diagram of a sensor 400 that may be included in the sample array 100. The electronic circuit may include a processor 402, a memory 404, a power source 406, etc., to record data from a sample substrate 408. In certain embodiments, the electronic circuit may include a communications module to transmit data to another device, such as another sample array 100, a central data collection system, a network, etc. In some embodiments, test samples 106 may not include any electronic circuits, but may instead passively react to conditions, such as by changing a material phase. Such test samples 106 may be removed after a period of time for analysis.

The sample array 100 may also include one or more test samples 106 configured to detect chemical species. In some embodiments, a test sample 106 may include two or more regions, each configured to detect different chemical species. FIG. 2 is a simplified schematic side view of a test sample 200, which may be any of the test samples 106 shown in FIG. 1. The test sample 200 may include a substrate 202, an optional intermediate material 204, and a chemically active layer 206. The substrate 202 may be the same as the substrate 102 shown in FIG. 1, or may be a separate substrate (e.g., the substrate 202 of the test sample 200 may be bonded to the substrate 102 shown in FIG. 1). The intermediate material 204, if present, may facilitate bonding between the chemically active layer 206 and the substrate 202. For example, the intermediate material 204 may be an adhesive material, a semiconductor material, a metal, an insulator, etc. In some embodiments, the chemically active layer 206 may be directly attached to the substrate 202, without any intermediate material 204.

The chemically active layer 206 may be any material formulated to interact with a chemical species, such that a concentration of the chemical species may be inferred based on analysis (either in situ or at a later time) of the chemically active layer 206. For example, the chemically active layer 206 may be configured to interact with CO₂, H₂S, chloride ions, iron ions, calcium ions, magnesium ions, chromium ions, manganese ions, hydroxyl ions or hydronium ions (i.e., to measure pH), etc. The chemically active layer 206 may include a nano-structured material (e.g., nanoparticles, etc.), such as in a coating over the substrate 202. Nano-structured materials may be useful as chemical detectors because they may be more selective toward a chemical species than, for example, continuous generally planar surfaces of the same material. Thus, a chemically active layer 206 containing nano-structured material may have a lower detection limit, may be more sensitive to relatively lower concentrations of a chemical species, and may yield results having a higher signal-to-noise ratio. However, in some embodiments, the chemically active layer 206 may include a generally planar surface of material, such as a metal, a metal oxide, etc.

The chemically active layer 206 may include different materials based on the chemical species to be detected. For example, to detect CO₂, the chemically active layer 206 may include CuO, BaTiO₃, SnO₂, iron oxide or another metal oxide in a perovskite form, etc. To detect H₂S, the chemically active layer 206 may include a metal oxide, such as CuO, SnO₂, WO₃, etc. To detect chloride ions, the chemically active layer 206 may include carbon, AgNO₃, WO₃, In₂O₃, Fe₂O₃, etc. To detect iron ions, the chemically active layer 206 may include a chalcogenide glass, a porphyrin, etc.

The chemically active layer 206 may be a homogeneous material in compositions, morphology, orientation, and surface roughness. If the chemically active layer 206 includes a nano-structured material, the chemically active layer 206 may have a relatively higher active surface area than a flat, smooth surface of similar composition. For example, the chemically active layer may having an active surface area at least 10 times, at least 50 times, or even at least 100 times the surface area of a flat surface of similar dimensions. Thus, the chemically active layer 206 may be relatively more sensitive to selected chemical species. Furthermore, a high surface area may enable measurement of a wider range of concentrations of chemical species than flat, smooth surfaces.

The test sample 200 may be formed by providing a precursor material over the substrate 202. For example, a precursor to the intermediate material 204 or to the chemically active layer 206 may be over the substrate 202. In some embodiments, the precursor may be deposited by, for example, screen printing, spin coating, evaporation, sputtering (physical vapor deposition), chemical vapor deposition, or any other selected method. The precursor may be heat-treated, which may form the intermediate material 204 or the chemically active layer 206. In embodiments in which the precursor forms the intermediate material 204, the chemically active layer 206 may be attached to the intermediate material 204. The chemically active layer 206 may deposited by, for example, screen printing, spin coating, evaporation sputtering, chemical vapor deposition, or any other selected method. If the chemically active layer 206 includes a nano-structured material, the nano-structured material may be formed in situ (e.g., by nucleation from a gas or liquid phase) or may be deposited as particles formed in a prior process.

In some embodiments, the chemically active layer 206 may include an electrically conductive material, which may respond to changes in electrical properties of a subterranean environment (e.g., pH, ion concentration, etc.).

In some embodiments, multiple test samples 200 may be formed in a single operation, and may be cut apart for use in individual sample arrays 100 (FIG. 1). Such a process may allow for economies of scale with respect to manufacturing, and may enhance quality control of the individual test samples 200 formed. Thus, sample arrays 100 may be prepared in large quantities, and the sample arrays 100 may be used interchangeably.

Returning to FIG. 1, the sample array 100 may include multiple test samples 106, and may include multiple test samples 106 configured to detect different chemical species or different concentration ranges of a chemical species. For example, the sample array 100 may include a test sample 106 for detecting downhole temperature (e.g., as disclosed in U.S. Pat. No. 5,130,705, “Downhole Well Data Recorder and Method,” issued Jul. 14, 1992, the entire disclosure of which is hereby incorporated by this reference), a test sample 106 for detecting chloride concentration (e.g., as disclosed in U.S. Pat. No. 6,925,392, “Method for Measuring Fluid Chemistry in Drilling and Production Operations,” issued Aug. 2, 2005, the entire disclosure of which is hereby incorporated by this reference), a test sample 106 for detecting a partial pressure of CO₂ (e.g., as disclosed in U.S. Patent Application Publication No. 2015/0122487, “Downhole Electrochemical Sensor and Method of Using Same,” published May 7, 2015, the entire disclosure of which is hereby incorporated by this reference), a test sample 106 for detecting a partial pressure of H₂S (e.g., as disclosed in U.S. Patent Application Publication No. 2015/0122487), a test sample 106 for detecting pH (e.g., as disclosed in U.S. Patent Application Publication No. 2015/0122487), and a test sample 106 for detecting a concentration of sulfur. Thus, the sample array 100 may provide multiple parameters that may be correlated to one another or to corrosion experienced by the corrosion proxy 104. Such information may be relatively more valuable when collected downhole rather than by a sample extracted at the surface of the earth because conditions may change en route to the surface, and collection of samples from various locations may become cost-prohibitive.

The sample array 100 may be removed from its location in a formation and brought to the surface for analysis. The sample array 100 may be analyzed by any appropriate means, such as spectroscopy (e.g., Raman, infrared, UV visible, etc.), thermogravimetric analysis, electrochemistry, etc. The sample array 100 may be analyzed in a laboratory using conventional laboratory equipment, or may be analyzed in a field-deployable module specifically adapted for use with the sample array 100. For example, the corrosion proxy 104 may be analyzed with a caliper to measure thickness, with an X-ray diffraction (XRD) device to determine microstructure, with an X-ray fluorescence (XRF) device to determine composition, with a scanning electron microscope (SEM) to determine surface topography, or with energy-dispersive X-ray spectroscopy (EDX) to determine elements present, or any other appropriate method or combination of methods. The test samples 106 of the sample array 100 may be separated from one another for analysis, and each may be analyzed by different methodology, which may be the same or different from methodology used to analyze the corrosion proxy 104 (e.g., XRD, XRF, SEM, EDX, etc.), depending on the chemical species to be analyzed. In embodiments in which one or more test samples 106 include electronic components such as a processor and/or memory, data may be transferred from those sample(s) 106 via a wired or wireless connection to a computer system.

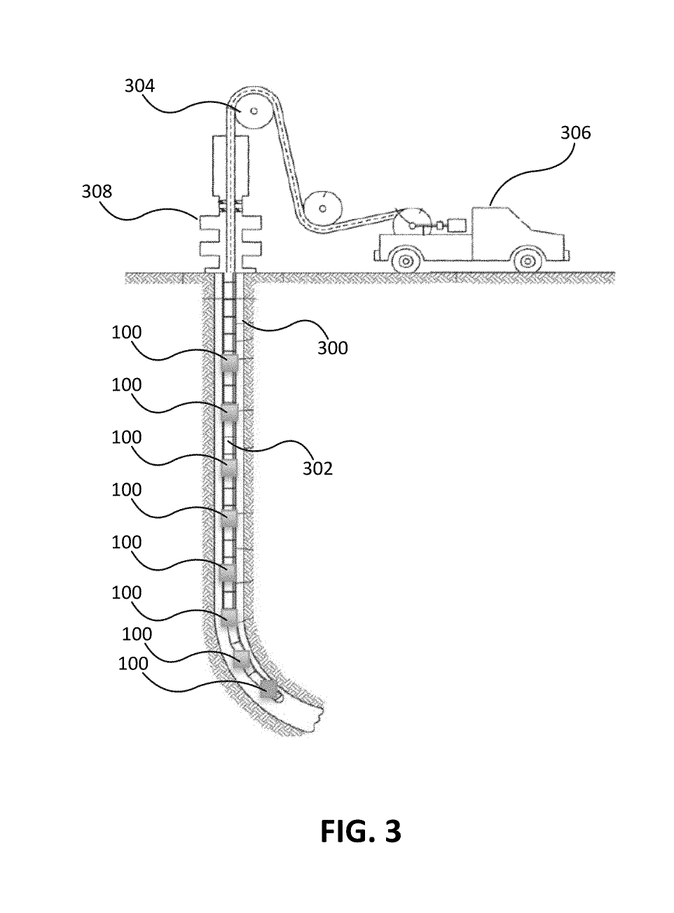

FIG. 3 is a simplified schematic diagram illustrating a cross-section of a subterranean formation, and shows how the sample array 100 shown in FIG. 1 may be used to monitor properties associated with corrosion. A number of sample arrays 100 may be provided within a borehole 300 to measure conditions therein. A wireline 302 may be placed within the borehole 300. The wireline 302 may be guided at the surface of the earth by one or more pulleys 304, a service truck 306, a derrick 308, or other known components. The wireline 302 may be a simple slickline with no active conductors for sending power and sending and receiving data, suspended within the borehole 300, but may alternatively be any other component. In some embodiments, the sample array 100 may be configured as a module inserted into the borehole 300 on a portion of a drill string or on coiled tubing.

The wireline 302 may carry a number of sample arrays 100 configured to measure conditions within the borehole 300. Each sample array 100 may be spaced apart from adjacent sample arrays 100 as desired to balance interests of, for example, costs, quality and quantity of data, speed of data analysis, etc. For example, sample arrays 100 may be spaced relatively close together in or near expected pay zones, in or near expected zones of high corrosion, etc., and relatively farther apart in areas of expected relatively inert wellbore fluids. The sample arrays 100 may be placed within the borehole 300 for a period of time, during which the sample arrays 100 are subjected to temperatures, pressures, chemical environments, etc., in the borehole 300. The sample arrays 100 may be removed after a period of time for analysis. The wireline 302 may be withdrawn from the borehole 300, and each sample array 100 may be removed from the wireline 302 for analysis. Thus, the sample arrays 100 may provide data from many different locations within the borehole 300. The sample arrays 100 may be separated into different parts for analysis in different equipment as desired.

In certain embodiments, for example, when run on a wireline 302 having active conductors for power and data transmission, the sample arrays 100 may communicate data to the surface (e.g., to a control panel on the service truck 306 or derrick 308) through the wireline 302, as is conventional. For example, the sample arrays 100 may transmit temperature and pressure to the surface. Transmission of data may be continuous or non-continuous.

In some embodiments, the corrosion proxy 104 may be measured independently of one or more of the test samples 106. For example, if one of the test samples 106 measures temperature or pressure continuously, the corrosion proxy 104 may measure corrosion over a period of time, such as over a period of hours, days, or weeks (as determined by gravimetric means, by measuring thickness, by analysis with XRD, XRF, SEM, EDX, etc.) by withdrawing the sample array 100 from service and analyzing the corrosion proxy 104. Thus, the temperature or pressure may be continuously transmitted to the surface, and the corrosion experienced by the corrosion proxy 104 may be measured at a point in time after exposure.

The sample arrays 100 may be used for any application in which additional information about corrosion would be beneficial, such as in upstream, midstream, or downstream operations. For example, one or more sample arrays 100 may be deployed to measure corrosion, physical properties, and chemical properties in piping within a processing plant (e.g., in flue pipes, material inputs, product outputs, intermediate flows, etc.). Such sample arrays 100 may assist operators in understanding conditions throughout a plant or other operation.

Use of sample arrays 100 as disclosed herein may enable data collection on a large scale, and may improve the ability to model corrosion processes by collecting specific physical and chemical properties near the site of corrosion proxies 104. The sample arrays 100 may be used to measure properties directly or indirectly. For example, a corrosion rate of one material may be measured directly by placing that material in the sample arrays 100 (e.g., as the corrosion proxy 104), or may be calculated based on parameters that may be measured directly, such as temperature, pressure, H₂S concentration, acidity, salinity, etc.

The sample arrays 100 may be configured to be stable and operable under conditions expected to be encountered in subterranean formations or hydrocarbon production systems. For example, the sample arrays 100 may be operable (i.e., may detect corrosion, physical, and/or chemical properties as designed) at pressures up to about 69 MPa (10,000 psi), up to about 138 MPa (20,000 psi) or even up to about 241 MPa (35,000 psi). The sample arrays 100 may be operable at temperatures up to about 150° C., up to about 205° C., or even up to about 260° C. or higher.

A method of characterizing downhole conditions may include providing one or more sample arrays 100 in a subterranean formation, analyzing the corrosion proxies 104 to estimate corrosion experienced by the sample arrays 100, and analyzing data collected from the test samples 106 to determine a physical property and/or a concentration of a chemical species.

The corrosion proxies 104 may be analyzed by gravimetric methods (i.e., by measuring a mass of each corrosion proxy 104). A change in mass of a corrosion proxy 104 may be correlated to a corrosion rate for a particular material. The test samples 106 may be analyzed by any appropriate method, such as by impedance spectroscopy, electrochemical methods, optical methods, microscopy, etc. For example, test samples 106 configured to measure temperature, pressure, fluid flow rate, vibration, acceleration, or electromagnetic field may record data on a digital storage medium, and the medium may be connected to a computer or a network to read the data. Test samples 106 configured to detect chemical species may be analyzed in a laboratory by, for example, reacting the test samples 106 with a reagent, dissolving a chemical species from the test samples 106, desorbing gaseous or liquid species from a surface of the test samples 106, extracting a chemical species from the test samples 106, measuring electrical properties of the test samples 106, analyzing the test samples 106 by spectroscopy, spectrometry, microscopy, x-ray, neutron activation, analysis of micro-structure, or any other method. Test samples 106 or portions thereof may be analyzed in different ways depending on the property to be measured. In some embodiments, test samples 106 may be cut or otherwise separated to promote efficient analysis (e.g., simultaneous analysis of different properties).

Data collected from sample arrays 100 may be used to correlate locations within a subterranean formation with corrosion levels. For example, zones of highly corrosive conditions may be identified in three dimensions (e.g., in a computer-generated, interactive visual representation), such that drilling operations may be better planned. For example, exposure of drill equipment to highly corrosive zones may be minimized or avoided altogether. If highly corrosive zones cannot be reasonably avoided, operators can focus monitoring and maintenance efforts on such zones if the location of the highly corrosive zones is well characterized. For example, equipment known to be exposed to highly corrosive zones may be inspected more frequently than other equipment, such that inspection efforts and resources can be used more efficiently.

Sample arrays 100 and methods as disclosed herein may offer advantages over conventional methods of measuring corrosion. For example, sample arrays 100 may enable an operator to economically place multiple sample arrays 100 in a formation to obtain information about conditions at multiple test sites. Furthermore, more information may be available at each test site because the sample arrays 100 may provide more information than conventional corrosion sensors, and may provide information with less exposure time. The use of multiple sample arrays 100 may therefore provide a more complete picture of downhole conditions and ongoing chemical reactions. Sample arrays 100 may be used to identify changes in a well related to productivity. Problems may be identified more quickly due to the sensitivity of sample arrays 100, and therefore problems may be corrected before catastrophic failures occur. Thus, overall well productivity may increase. The use of sample arrays 100 may enable a shift from time-based maintenance schedules toward condition-based maintenance, and, thus, may allow more efficient allocation of maintenance resources. Furthermore, sample arrays 100 may allow operators to test novel corrosion inhibitors and to improve the efficiency of corrosion inhibitor treatments.

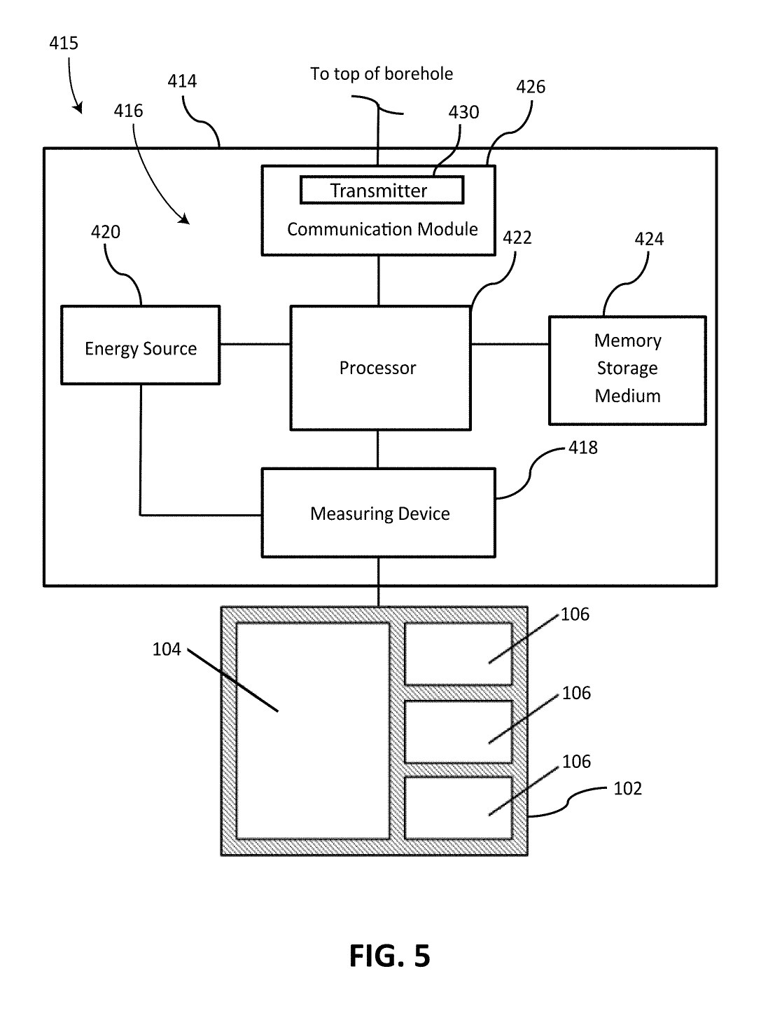

FIG. 5 is a schematic view of a sensor system 415 according to an embodiment of the present disclosure. The sensor system 415 may collect data related to corrosion conditions, chemical conditions, and scale conditions (hereinafter “corrosion conditions”) and may communicate the collected corrosion data to a top surface (e.g., ground level surface or top of the borehole 300 (FIG. 3)) from downhole. In some embodiments, the sensor system 415 may include a multi-variable sensor system 415. In other words, the sensor system 415 may collect data related to multiple conditions. For example, in some embodiments, the sensor system 415 may collect data may collect data (referred to hereinafter as “corrosion data”) related to corrosion conditions, physical conditions, and chemical conditions (referred to hereinafter collectively as “corrosion conditions”). In some embodiments, the sensor system 415 may communicate the corrosion data to the top surface in real-time.

The sensor system 415 may be similar to the sample arrays 100 of FIGS. 1-3. For example, the sensor system 415 may include a substrate 102, a corrosion proxy 104, a first test sample 106, and a second test sample 106. However, the sensor system 415 may also include an electronic circuit 416 coupled to the first test sample 106 and second test sample 106. The electronic circuit 416 may include a measuring device 418, an energy source 420, a processor 422, a first memory storage medium 424, and a communication module 426. Furthermore, to protect the electronic circuit 416, the sensor system 415 may include an environmental shielding 414 at least partially surrounding the electronic circuit 416.

Similar to the sample arrays 100 described above in regard to FIG. 3, the sensor system 415 may be disposable within a borehole 300 (FIG. 3) along a wireline 302 (FIG. 3). In some embodiments, each sensor system 415 may be spaced apart from adjacent sensor systems 415 within a borehole as desired to balance interests of, for example, costs, quality and quantity of data, speed of data analysis, etc. For example, sensor systems 415 may be spaced relatively close together in or near expected pay zones traversed by the borehole, in or near expected zones of high corrosion, etc., and relatively farther apart in areas of expected inert material. The sensor systems 415 may be placed within the borehole 300 for a period of time, during which the sensor systems 415 are subjected to temperatures, pressures, chemical environments, etc., in the borehole 300. Thus, the sensor systems 415 may provide data from many different locations within the borehole 300. In some embodiments, the sensor systems 415 may provide corrosion data within three spatial coordinates (e.g., x, y, and z).

The first test sample 106 and second test sample 106 of the sensor systems 415 may operate in substantially the same manner as described above in regard to FIGS. 1-3. For example, the first test sample 106 may be formulated and configured to measure a physical property of the corrosion proxy 104 (e.g., a first corrosion condition), and the second test sample 106 may be formulated and configured to measure a chemical species of the corrosion proxy 104 (e.g., a second corrosion condition). For example, the first test sample 106 and the second test sample 106 may measure corrosion severity, concentration of corrosion, and environmental properties such as chloride ion, pH, H₂S, CO₂, Fe-ion, temperature, etc. Furthermore, in some embodiments, the first test sample 106 and the second test sample 106 may include micro-electro-mechanical-systems (“MEMS”), biological sampling units, etc. Although the sensor system 415 is described herein as having a first test sample 106 and a second test sample 106, the disclosure is not so limited, and one of ordinary skill in the art would readily recognize that the sensor system 415 could include any number of sensors. For example, the sensor system 415 may include a third sensor, a fourth sensor, a fifth sensor, etc.

The measuring device 418 may be coupled to the first test sample 106 and the second test sample 106. The measuring device 418 may be configured to interrogate (e.g., analyze) the first test sample 106 and the second test sample 106 to obtain data and/or readings related to corrosion rates and corrosion conditions. For example, the measuring device 418 may include one or more of an electronic measuring device and an optical measuring device to analyze the first test sample 106 and the second test sample 106. As a non-limiting example, the measuring device 418 may include both of an electronic measuring device and an optical measuring device to analyze the first test sample 106 and the second test sample 106. In some embodiments, the measuring device 418 may analyze the first test sample 106 and the second test sample 106 through one or more of spectroscopy (e.g., Raman, infrared, UV visible, etc.), thermogravimetric analysis, electrochemistry, etc. In some embodiments, the measuring device 418 may be configured to interrogate (e.g., analyze) the corrosion proxy 104.

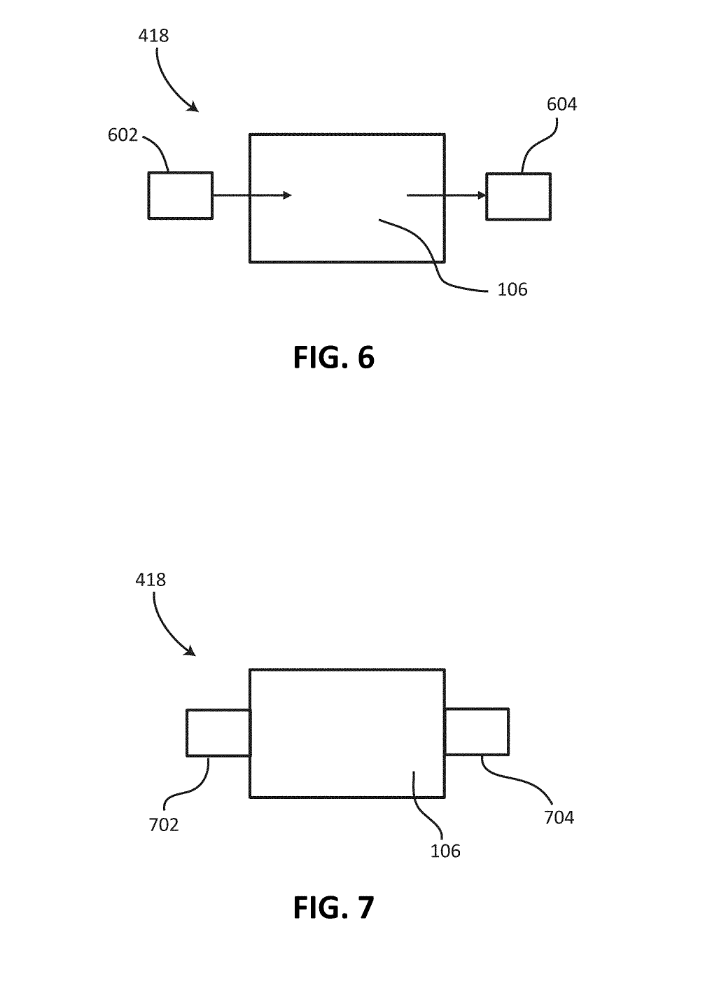

FIG. 6 is a simplified measuring device 418 including an optical measuring device. The measuring device 418 may include an emitter 602 and a receiver 604. During operation, the emitter 602 may emit light on a test sample 106 and the light may be at least partially reflected to the receiver 604 such that some of the light is at least partially captured and/or measured by the receiver 604 (e.g., capturing and/or measuring a visual image, light reading, illuminance, reflectiveness, etc., of the test sample). In some embodiments, the emitter 602 may include one or more of a laser-emitting diode, laser, infrared transmitter, UV emitter, or any other light source. In some embodiments, the receiver 604 may include an image capturing device, infrared sensor, UC sensor, light reader/measurer, etc. In some embodiments, the light captured and/or measured may indicate a corrosion condition.

FIG. 7 is a simplified measuring device 418 including an electronic measuring device. The measuring device 418 may include a first electrical contact 702 and a second electrical contact 704. The first and second electrical contacts 702, 704 may be in contact with a test sample 106. The measuring device 418 may subject the test sample 106 to one or more of a current, voltage, magnetic field, etc. Moreover, the measuring device 418 may measure one or more of a resistance of the test sample 106, a current passing through the test sample 106, a voltage across the test sample 106, a capacitance of the test sample 106, etc. The measurements taken by the measuring device 418 may indicate a corrosion condition.

Referring back to FIG. 5, the energy source 420 may be operably coupled to the measuring device 418 and the processor 422 and may provide power to the measuring device 418 and the processor 422. In some embodiments, the energy source 420 may include one or more of a battery, energy obtained through the wireline 302 (FIG. 3), or any other energy source that may be used in high pressure high temperature (“HPHT”) environments.

The processor 422 may be electrically and operably coupled to the measuring device 418 and the first memory storage medium 424. The processor 422 may process any data, measurements, and/or readings related to corrosion conditions (hereinafter “the corrosion data”) acquired by the measuring device 418. Furthermore, the processor 422 may cause the corrosion data to be stored (e.g., recorded) in the first memory storage medium 424. The first memory storage medium 424 may include any electronic non-volatile storage mediums, such as, for example, Flash memory.

The communication module 426 may be operably coupled to the processor 422, and the processor 422 may relay (e.g., send) the corrosion data to the communication module 426. The communication module 426 may include a transmitter 430 for transmitting the corrosion data to the top surface. In some embodiments, the communication module 426 may transmit the corrosion data via the transmitter 430 to the top surface in at least substantially real-time. In other words, the communication module 426 may transmit the corrosion data to the top surface at least substantially as the measuring device 418 obtains and/or measures the corrosion data. In some embodiments, the transmitter 430 of the communication module 426 may include one or more of a radio transmitter, a wireless transmitter, a communication cable, a fiber optic cable, the wireline 302, a mud pulse telemetry systems, etc.

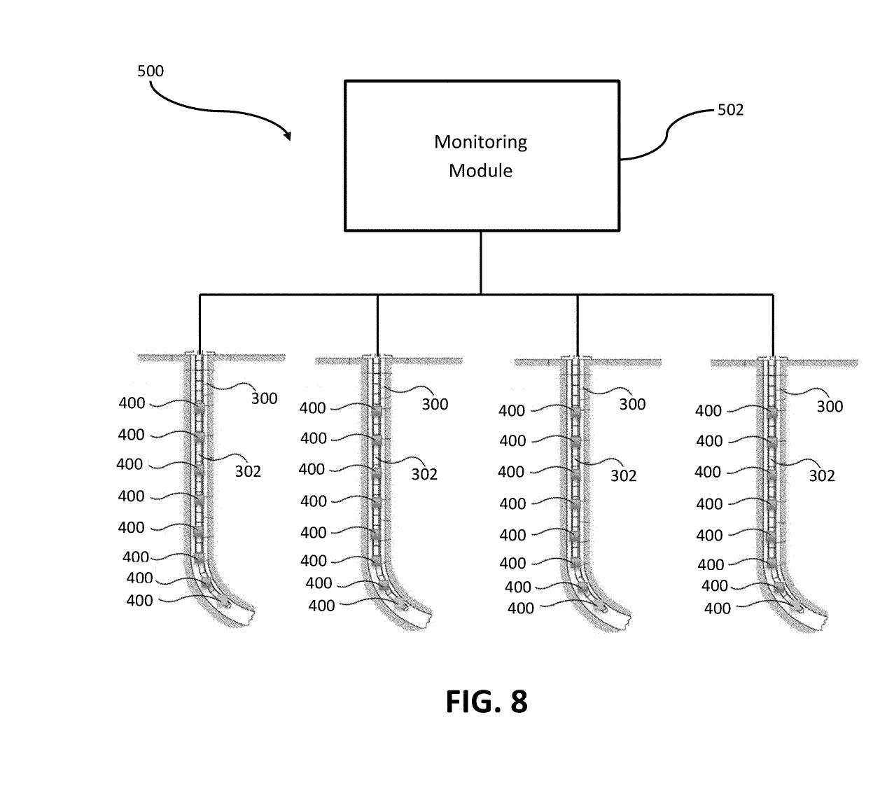

FIG. 8 is a schematic view of a multi-borehole monitoring system 500 for monitoring corrosion downhole throughout a geographical area (e.g., throughout multiple boreholes 300 in the geographical area). The multi-borehole monitoring system 500 may include a plurality of sensor systems 415 disposed in a plurality of boreholes 300. In some embodiments, the multi-borehole monitoring system 500 may include multiple sensor systems 415 disposed in each borehole 300 of the plurality of boreholes 300. The multi-borehole monitoring system 500 may further include a monitoring module 504. Each sensor system 415 of the plurality of sensor systems 415 may be in communication with the monitoring module 502.

In some embodiments, the plurality of sensor systems 415 may be in wired communication with the monitoring module 502. For example, each sensor system 415 may be in communication with the monitoring module 502 through one or more cables. In other embodiments, the plurality of sensor systems 415 may be in wireless communication with the monitoring module 502. For example, the plurality of sensor systems 415 may communicate with the monitoring module 502 through one or more of Wi-Fi, BLUETOOTH®, infrared, radio, microwave, or cellular signals.

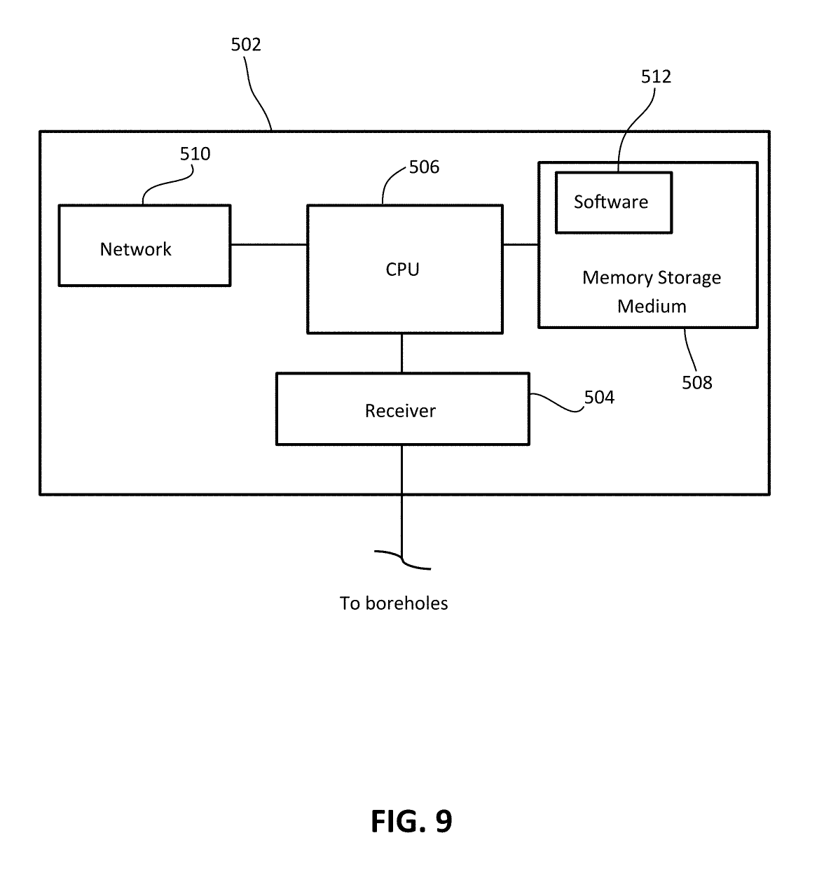

FIG. 9 is a schematic view of the monitoring module 502 of the multi-borehole monitoring system 500 (FIG. 8). The monitoring module 502 may include at least one receiver 504, a central processing unit (“CPU”) 506, a second memory storage medium 508, and a network 510. The second memory storage medium 508 may have at least one software program 512 installed thereon, and the CPU 506 may be configured to execute (e.g., run or operate) the at least one software program 512.

Referring to FIGS. 8 and 9 together, the at least one receiver 504 may be in communication with the communication modules 426 (FIG. 5) of the plurality of sensor systems 415 and may receive the corrosion data from the plurality of sensor systems 415. In some embodiments, the monitoring module 502 may include a single receiver 504 in communication with all of the plurality of sensor systems 415. In other embodiments, the monitoring module 502 may include a plurality of receivers 504. For example, the monitoring module 502 may include a receiver 504 for each borehole 300 of the plurality of boreholes 300 covered by the multi-borehole monitoring system 500. In such embodiments, the plurality of receivers 504 may be located at a top surface of a respective borehole 300.

The at least one receiver 504 may transmit the corrosion data received from the plurality of sensor systems 415 to the CPU 506. In some embodiments, the at least one receiver 504 may include one or more of a radio receiver, a wireless receiver, a modem, etc.

The CPU 506 may process the corrosion data received from the at least one receiver 504. As used herein, the phrase “process data” and any derivative terms may refer to collecting and/or manipulating the data to produce meaningful information. In some embodiments, the CPU 506 may process the corrosion data with the software program 512 installed on the second memory storage medium 508. The CPU 506 may further transmit the corrosion data to second memory storage medium 508, and the CPU 506 may cause the corrosion data to be recorded (e.g., stored within the second memory storage medium 508.

The CPU 506 may further be operably coupled to the network 510. In some embodiments, the CPU 506 may transmit the corrosion data received from the plurality of sensor systems 415 to the network 510. Furthermore, the CPU 506 may transmit any data and/or information produced by processing the corrosion data to the network 510. In some embodiments, the network 510 may include connections to other multi-borehole monitoring systems 500 (e.g., one or more other multi-borehole monitoring systems 500) covering other geographical areas. In some embodiments, the network 510 may include connections to other multi-borehole monitoring systems 500 covering the same geographical area but collecting and analyzing different data. In some embodiments, the network 510 may include connections to proprietary company networks or satellite systems. In some embodiments, the network 510 may include at least one connection to the Internet, and the multi-borehole monitoring system 500 may transmit the corrosion data received from the plurality of sensor systems 415 and the data and/or information produced by processing the corrosion data to the Internet. Accordingly, the corrosion data and any resulting data and/or information may be accessible offsite (e.g., at some location other than the location of the multi-borehole monitoring system 500) via the Internet.

In some embodiments, the multi-borehole monitoring system 500 may be configured to process and analyze the corrosion data received from the plurality of sensor systems 415 located within the plurality of boreholes 300, and to use and/or manipulate the corrosion data to inform corrosion management practices and future field developments (e.g., development of future boreholes 300). In some embodiments, the corrosion data may inform implementation, review, and maintenance of a corrosion management practices. For example, the multi-borehole monitoring system 500 may process the corrosion data and may produce a visual representation of the corrosion data. In some embodiments, the visual representation may include one or more of a two-dimensional map, a three-dimensional map, a graph plot (e.g., plot having a variable (e.g., corrosion severity) vs. time), etc.

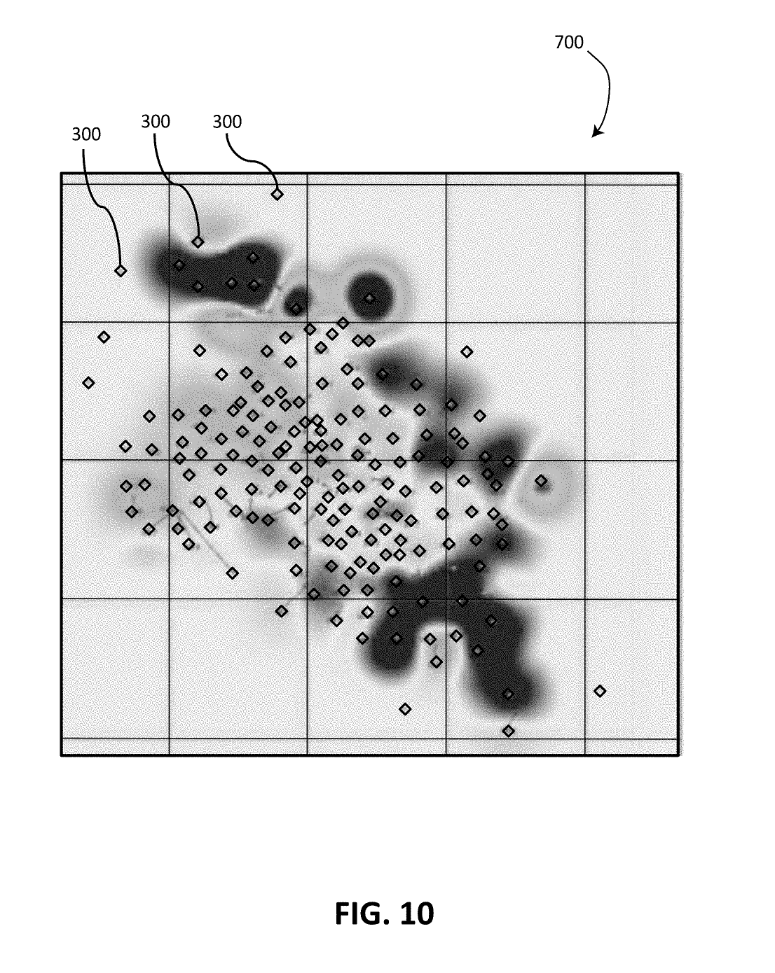

FIG. 10 is an example representation of a basin level subsurface map 700 that may be produced by the multi-borehole monitoring system 500. Referring to FIGS. 8-10 together, in some embodiments, the multi-borehole monitoring system 500 may process the corrosion data received from the plurality of sensor systems 415 and may create a basin level subsurface map 700 of corrosion conditions within the geographical area covered by the multi-borehole monitoring system 500. For example, the multi-borehole monitoring system 500 may collect corrosion data from the plurality of boreholes 300 and may, for a given depth, produce a basin level subsurface map 700 indicating the corrosion conditions of each borehole 300 of the plurality of boreholes 300 at that depth. Furthermore, the plurality of boreholes 300 may be mapped across the geographical area such that a map of the corrosion conditions of the geographical area (e.g., field) may be mapped as well.

The basin level subsurface map 700 may indicate types of corrosion, severity of corrosion, and concentrations of corrosion. The basin level subsurface map 700 may indicate types of corrosion, severity of corrosion, and concentrations of corrosion with one or more of colors, symbols, proximity of symbols, or any other known methods for indicating items on a map. In some embodiments, the basin level subsurface map 700 may be produced via the software 512 installed on the second memory storage medium 508 of the multi-borehole monitoring system 500. For example, the basin level subsurface map 700 may be produced via JEwELSUITE™.

In some embodiments, the multi-borehole monitoring system 500 may process the corrosion data received from the plurality of sensor systems 415 and may create a three-dimensional subsurface model (“3D subsurface model”) of the geographical area indicating the corrosion conditions of each borehole 300 of the plurality of boreholes 300 along a depth of the plurality of boreholes 300. For example, the multi-borehole monitoring system 500 may produce multiple basin level subsurface maps 700 along the depth of the plurality of boreholes 300 and may merge the multiple basin level subsurface maps 700 to produce the 3D subsurface model. In some embodiments, the multi-borehole monitoring system 500 may just use the corrosion data received from the plurality of sensor systems 415 to produce the 3D subsurface model instead of merging the data of the multiple basin level subsurface maps 700.

The multi-borehole monitoring system 500 may interpolate corrosion conditions of areas between the plurality of boreholes 300 having sensor systems 415 disposed therein based on the types of corrosion, severity of corrosion, and concentrations of corrosion measured by the sensor systems 415. For example, in some embodiments, the geographical area monitored by the multi-borehole monitoring system 500 may include boreholes 300 (e.g., wells) that do not have sensor systems 415 disposed therein (hereinafter “non-sensing boreholes 300”). In such instances, the multi-borehole monitoring system 500 may interpolate the conditions (e.g., corrosion conditions) of the non-sensing boreholes 300 based on the corrosion data available around the non-sensing boreholes 300 (e.g., from boreholes 300 having sensor systems 415 disposed therein). Furthermore, the corrosion data available from boreholes 300 having sensor systems 415 disposed therein may be interpolated to areas (e.g., geographical areas) not having boreholes 300 formed therein (e.g., areas of potential future boreholes 300).

The basin level subsurface maps (hereinafter “maps”) and/or 3D subsurface models (hereinafter “models”) may inform corrosion management practices and future field developments. As discussed above, the corrosion data and resulting maps and models may inform implementation, review, and maintenance of a corrosion management practices. Furthermore, the corrosion data and resulting maps and models may assist in monitoring corrosion downhole, assessing corrosion levels/severity downhole, and correcting corrosion induced problems downhole. For example, the maps and models may provide information on where corrosion is most severe and most concentrated within the geographical area. Based on the information provided by the maps and models, areas of high corrosion (i.e., hotspots) can be avoided in future developments (e.g., future boreholes 300). Furthermore, areas of low corrosion (i.e., sweet spots) can be pinpointed and targeted in future developments. By being able to make informed decisions about future developments of the field at a subsurface level, lifetimes of boreholes 300 (i.e., wellbores) and associated equipment can be increased. Furthermore, by being able to make informed decisions about future developments of the field at a subsurface level, workover, stimulation, treatment, well completion, production, installation, and repair costs may be reduced for future boreholes 300 and equipment. Moreover, current borehole 300 (e.g., well) integrity may be at least partially determined from the corrosion data and resulting maps and models.

Furthermore, by comparing the maps and models with production data of the boreholes 300 (e.g., production of oil, gas, etc.), the multi-borehole monitoring system 500 may produce a cost versus benefits analysis weighing the corrosions levels and expected costs of drilling and maintaining the borehole 300 against an expected production of the borehole 300. Thus, an efficiency of the field (e.g., plurality of boreholes 300) throughout the geographical area may be increased.

Moreover, the multi-borehole monitoring system 500 may compare the maps, models, and corrosion data with other aspects of the geographical area, such as, a presence of chemicals, production data, water cuts, seismic profiles, depth of the sensor systems 415, pressures, temperatures, rock properties, stress concentrations, and/or stress maps. For example, the maps and models may be superimposed with other aspects of the geographical area by the multi-borehole monitoring system 500 using the software 512. For example, the multi-borehole monitoring system 500 may superimpose other aspects of the geographical area with the corrosion maps and models using software 512, such as, JEWELSUITE™. Such comparisons may enable the multi-borehole monitoring system 500 to determine correlations between corrosion and the other aspects of the geographical area. By finding correlations, the multi-borehole monitoring system 500 may determine sources and/or agitators (e.g., accelerators) of corrosion and scale specific to the geographical area or generally. Furthermore, in some embodiments, the comparisons may be used by the multi-borehole monitoring system 500 to predict water cuts, stress concentrations, rock properties, etc. Moreover, the multi-borehole monitoring system 500 may superimpose and/or combine the corrosion data and resulting maps and models with data collected from other monitoring tools such as data related to chemical properties, microbial properties, fluid behaviors, etc. For example, the multi-borehole monitoring system 500 may receive additional inputs (e.g., data) from other monitoring tools, and in some embodiments, may receive such inputs via the network 510.

In some embodiments, the multi-borehole monitoring system 500 may collect the corrosion data from the plurality of sensor systems 415 over a period of time. For example, the multi-borehole monitoring system 500 may collect corrosion data over a period of a week, a month, a year, a decade, etc. In other words, collecting the corrosion data from the plurality of sensor systems 415 may be an on-going process. Furthermore, the multi-borehole monitoring system 500 may compare the corrosion data over the period of time. For example, over a time period, the multi-borehole monitoring system 500 may compare basin level subsurface maps 700 produced at different times during that time period. As a non-limiting example, the monitoring module 502 may receive and record a first set of corrosion data from the plurality of sensor systems 415 and a second set of corrosion data from the plurality of sensor systems 415. The first set of corrosion data may represent a first time period and the second set of corrosion data may represent a second later time period. The monitoring module 502 may then compare the first set of corrosion data with the second set of corrosion data.

By comparing the basin level subsurface maps 700 produced at different times during a time period, the multi-borehole monitoring system 500 may determine corrosion and chemical changes during that time period throughout the geographical area. Additionally, by comparing the basin level subsurface maps 700 and/or corrosion data produced at different times during a time period, the multi-borehole monitoring system 500 may determine tendencies of the corrosion, rates at which the corrosion develops (e.g., spreads), and when corrosion may reach other locations within the geographical area (e.g., other boreholes 300). In other words, the multi-borehole monitoring system 500 may determine behaviors of the corrosion.

By determining behaviors of the corrosion, the multi-borehole monitoring system 500 may determine and/or project when maintenance and/or work may need to be performed on the plurality of boreholes 300. Furthermore, by determining behaviors of the corrosion (e.g., rate at which corrosion is developing (e.g., spreading) and severity), the multi-borehole monitoring system 500 may determine and/or project expected lifetimes of boreholes 300 within the geographical area. Moreover, the multi-borehole monitoring system 500 may record and determine interactions of different types of corrosions and may project resulting effects on current and future boreholes 300. Additionally, by determining behaviors of the corrosion (e.g., rate at which corrosion is developing (e.g., spreading) and severity), the multi-borehole monitoring system 500 may predict and/or interpolate future corrosion development and severity.

By predicting and/or interpolating future corrosion development and severity, the multi-borehole monitoring system 500 may inform decisions about future borehole 300 drilling procedures and locations.

In some embodiments, the geographical area (e.g., field) may include corrosion and scale inhibitors. In such embodiments, by determining behaviors of the corrosion, the multi-borehole monitoring system 500 may determine the effectiveness's of the corrosion and scale inhibitors. An as a result, the multi-borehole monitoring system 500 could determine where within the geographical area a corrosion and scale inhibitor may be most effective and/or need to be implemented.

Because the multi-borehole monitoring system 500 may be connected to the Internet via the network 510, any of the information, corrosion data, maps, models, and analysis described above may be readily available to developers, corrosion management, and field management at offsite locations. For example, developers, corrosion management, and field management may be located in another country and may be able to analyze the information provided by the multi-borehole monitoring system 500. Furthermore, the developers, corrosion management, and field management may be able to make informed decisions in regard to corrosion without being on-site (e.g., located at the actual plurality of boreholes 300 or a respective geographical area). Furthermore, the multi-borehole monitoring system 500 may provide the information in at least substantially real-time. In other words, the information may be available to the developers, corrosion management, and field management via the Internet in at least substantially real-time. As a result, developers, corrosion management, and field management may monitor corrosion changes and/or behaviors in real-time via the Internet.

Referring to FIGS. 5-8 together, the corrosion data obtained by the multi-borehole monitoring system could be integrated with other forms of data including geology, petrology, production, well treatment, workover, and failure logs data. Furthermore, the corrosion data could be used by developers, corrosion management, and field management for “what if” analysis. For example, the corrosion data could be used by developers, corrosion management, and field management to determine well placement, well trajectory, metallurgy of tubular and tools, and type of equipment. Moreover, the corrosion data could be used in advanced data analysis, chemometrics, machine learning, deep learning to uncover unknown correlations, prediction of behavior, and early warning of failures. In some embodiments, the corrosion data could be used to perform corrosion-stratigraphy and chemo-stratigraphy.

Moreover, the corrosion data, resulting maps and models, and comparisons with other types and sources of data may inform future designs, future material selections, and future control measures (e.g., corrosion inhibitors) used in current and future boreholes 300 (FIG. 3).

In some embodiments, the present disclosure includes a multi-borehole monitoring system for monitoring downhole corrosion in multiple boreholes, comprising: a plurality of sensor systems disposed in multiple boreholes within a geographical area, each sensor system of the plurality of sensor systems comprising: a first test sample formulated and configured to measure a first corrosion condition of a respective borehole; and a second test sample formulated and configured to measure a second corrosion condition of a respective borehole. The multi-borehole monitoring system may further include a monitoring module configured to receive corrosion data related to each of plurality of sensor systems. The monitoring module may comprise: a central processing unit configured to process the corrosion data received by the monitoring module and a memory storage medium operably coupled to the central processing unit, wherein the monitoring module is configured to analyze the corrosion data received by the monitoring module, to manipulate the corrosion data, and to produce a visual representation of the corrosion data.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention. Further, embodiments of the disclosure have utility with different and various tool types and configurations.

What is claimed is:

1. A sensor system for monitoring corrosion, comprising:
a sample array, comprising:
a substrate;
a corrosion proxy coupled to the substrate and comprising a corrodible material;
a first test sample coupled to the substrate, the first test sample formulated and configured to measure a first corrosion condition; and
a second test sample coupled to the substrate, the second test sample formulated and configured to measure a second corrosion condition; and
an electronic circuit operably coupled to the sample array, comprising:
a measuring device located and configured to analyze the first test sample and the second test sample and to obtain corrosion data related to the first corrosion condition and the second corrosion condition;
a processor electrically and operably coupled to the measuring device and configured to process the corrosion data related to the first corrosion condition and the second corrosion condition; and
a communication module having a transmitter and operably coupled to the processor, the communication module configured to transmit the processed corrosion data related to the first corrosion condition and the second corrosion condition to a surface above a borehole.

2. The sensor system of claim 1, wherein the electronic circuit further comprises an energy source configured to provide power to the measuring device and the processor.

3. The sensor system of claim 1, wherein the electronic circuit further comprises a memory storage medium operably coupled to the processor.

4. The sensor system of claim 3, wherein the processor of the electronic circuit is configured to store the corrosion data related to the first corrosion condition and the second corrosion condition in the memory storage medium.

5. The sensor system of claim 1, further comprising environmental shielding at least substantially surrounding the electronic circuit of the sensor system.

6. The sensor system of claim 1, wherein the electronic circuit of the sensor system is configured to transmit the corrosion data related to the first corrosion condition and the second corrosion condition to the surface above the borehole in at least substantially real-time.

7. The sensor system of claim 1, wherein the measuring device comprises an optical interface.

8. The sensor system of claim 1, wherein the measuring device comprises an electronic interface.

9. A multi-borehole monitoring system for monitoring downhole corrosion in multiple boreholes, comprising:
a plurality of sensor systems disposed in multiple boreholes within a geographical area, each sensor system of the plurality of sensor systems comprising:
a first test sample formulated and configured to measure a first corrosion condition of a respective borehole;
a second test sample formulated and configured to measure a second corrosion condition of a respective borehole; and
an electronic circuit operably coupled to the first test sample and the second test sample, comprising:
a measuring device located and configured to analyze the first test sample and the second test sample and to obtain corrosion data related to the first corrosion condition and the second corrosion condition; and
a communication module having a transmitter and operably coupled to the measuring device, the communication module configured to transmit the corrosion data related to the first corrosion condition and the second corrosion condition; and
a monitoring module in communication with the plurality of sensor systems, comprising:
a receiver for receiving the corrosion data from the communication module of each sensor system of the plurality of sensor systems;
a central processing unit operably coupled to the receiver and configured to process the corrosion data received by the receiver; and
a memory storage medium operably coupled to the central processing unit,
wherein the monitoring module is configured to analyze the corrosion data received by the receiver, to manipulate the corrosion data, and to produce a visual representation of the corrosion data.

10. The multi-borehole monitoring system of claim 9, wherein the monitoring module further comprises a network operably coupled to the central processing unit and configured to connect the monitoring module to the Internet.

11. The multi-borehole monitoring system of claim 9, wherein the central processing is configured to record the corrosion data on the memory storage medium.

12. The multi-borehole monitoring system of claim 9, wherein manipulating the corrosion data and producing the visual representation of the corrosion data comprises producing a basin level subsurface map of the geographical area showing corrosion concentrations and severity.

13. The multi-borehole monitoring system of claim 9, wherein manipulating the corrosion data and producing the visual representation of the corrosion data comprises producing a 3D model of a subsurface of the geographical area, the 3D model showing corrosion concentrations and severity.

14. The multi-borehole monitoring system of claim 9, wherein the monitoring module is configured to receive a first set of corrosion data from the communication module of each sensor system of the plurality of sensor systems, the first set of corrosion data representing a first time period, and to receive a second set of corrosion data from the communication module of each sensor system of the plurality of sensor systems, the second set of corrosion data representing a second later time period, and wherein the monitoring module is configured to compare the first set of corrosion data with the second set of corrosion data.

15. The multi-borehole monitoring system of claim 14, wherein the monitoring module is configured to determine rates at which corrosion is developing by comparing the first set of corrosion data with the second set of corrosion data.

16. A method of monitoring downhole conditions, comprising:
disposing a sensor system in a borehole formed in a subterranean formation, the sensor system comprising:
a first test sample formulated and configured to measure a first corrosion condition of the borehole; and
a second test sample formulated and configured to measure a second corrosion condition of the borehole; and
an electronic circuit operably coupled to the first test sample and the second test sample, comprising:
a measuring device configured to analyze the first test sample and the second test sample and to obtain corrosion data related to the first corrosion condition and the second corrosion condition; and
a communication module having a transmitter and operably coupled to the measuring device, the communication module configured to transmit the corrosion data related to the first corrosion condition and the second corrosion condition;
causing the measuring device to analyze the first test sample and the second test sample and to obtain the corrosion data related to the first corrosion condition and the second corrosion condition; and
causing the communication module to transmit the corrosion data related to the first corrosion condition and the second corrosion condition to a receiver of a multi-borehole monitoring system located at a ground surface of the subterranean formation.

17. The method of claim 16, further comprising:
processing the corrosion data with a processor of the multi-borehole monitoring system; and
producing, with the processor, a visual representation of the corrosion data.

18. The method of claim 17, further comprising acquiring over time multiple sets of corrosion data, each set of corrosion data of the multiple sets of corrosion data correlating to a different time period, and wherein producing, with the processor, the visual representation of the corrosion data comprises producing a basin level subsurface map showing corrosion concentrations and severity of the subterranean formation for each set of corrosion data of the multiple sets of the corrosions data.

19. The method of claim 17, wherein producing, with the central processing unit, the visual representation of the corrosion data comprises producing a 3D model of the subterranean formation showing corrosion concentrations and severity of the subterranean formation.

20. The method of claim 16, further comprising transmitting the corrosion data to the Internet via a network of the multi-borehole monitoring system.
